(19) United States
(12) Patent Application Publication
(10) Pub. No.: US 2014/0088992 A1
(43) Pub. Date: Mar. 27, 2014

(54) METHOD AND SYSTEM FOR DETECTING AND CATEGORIZING DISEASE

(71) Applicant: THE TRUSTEES OF THE UNIVERSITY OF PENNSYLVANIA, Philadelphia, PA (US)

(72) Inventors: Barry Fuchs, Merion, PA (US); Richard Urbani, Philadelphia, PA (US); Perry Wilson, Philadelphia, PA (US); Satjeet Khaisa, Philadelphia, PA (US)

(73) Assignee: THE TRUSTEES OF THE UNIVERSITY OF PENNSYLVANIA, Philadelphia, PA (US)

(21) Appl. No.: 14/032,141

(22) Filed: Sep. 19, 2013

Related U.S. Application Data
(60) Provisional application No. 61/702,925, filed on Sep. 19, 2012.

(51) Int. Cl. G06F 19/00

(52) U.S. Cl. CPC G06F 19/345
USPC 705/2

(57) ABSTRACT

The presently disclosed subject matter relates to the diagnosis of diseases, and more particularly to the diagnosis of diseases using information contained within an electronic medical record. In particular, the presently disclosed subject matter provides for systems and methods for monitoring, detecting and categorizing disease states. In one embodiment, the system and method can include determining the present or indication of one or more disease state criteria and alerting the hospital information system and at least one clinician if at least one or more disease state criteria are present or indicated.

### CROSS REFERENCE TO RELATED APPLICATIONS

This application claims the benefit of U.S. Provisional Application Ser. No. 61/702,925 filed Sep. 19, 2012, which is hereby incorporated by reference in its entirety.

### FIELD OF INVENTION

The presently disclosed subject matter relates to the diagnosis of diseases, and more particularly to the diagnosis of diseases using information contained within an electronic medical record.

### BACKGROUND

In the United States, there are over 5 million infectious disease-related illnesses cases reported by hospitals annually. Significantly greater numbers remain undetected, both in the inpatient and community setting, resulting in substantial morbidity and mortality. Critical intervention for infectious disease and resulting illnesses/injuries relies on rapid, sensitive and specific detection of the offending pathogen. Unfortunately, despite the recognition that outcomes from infectious illnesses are directly associated with time to pathogen recognition, conventional hospital laboratories often remain encumbered by traditional slow multi-step culture based assays.

Acute kidney injury (AKI) is a common complication associated with hospitalization. Patients can develop AKI in the first couple of days of hospitalization, resulting from the effects of their presenting illness. AKI can also occur later in the hospitalization as a result of either progression of the presenting illness or as a complication of hospitalization including a new illness (e.g., sepsis) or a complication of a treatment or intervention.

The development of AKI is associated with a dramatic increase in mortality and hospital costs, wherein the development of AKI confers a 6.9 fold to 8.9 fold increase in the odds of in-hospital mortality and confers increased hospital costs of $8,902 to $15,192 per patient for the same diagnosis related group. In a study performed by the University of Pennsylvania Health System (UPHS) it was determined that in a cohort of 6,119 patients with severe acute kidney injury, identified from Jan. 1, 2004-Aug. 31, 2010 at HUP, Pennsylvania Medical Center (PMC), and Pennsylvania Hospital (PAH), clinician documentation of AKI was poor. One of the reasons for the failure to document AKI may be due to the failure to recognize AKI accurately and/or rapidly, which is associated with increased in-hospital mortality. This association may relate to delays in recognizing associated clinical conditions whose treatments are time-sensitive, e.g., severe sepsis, or because of delays in interventions aimed at reversing AKI. The adverse impact of AKI on patient outcomes, underscores the importance of improving its timely recognition.

Identification of novel and efficient systems and methods for detecting and categorizing disease states would enable hospital to decrease disease-related morbidity and mortality, improve hospital performance and perceived quality. In addition, the reporting entity may increase their reimbursement for the captured diagnosis, and one that pays reasonably well.

### SUMMARY

The presently disclosed subject matter relates to systems and methods for detecting and categorizing disease states. In particular, the presently disclosed subject matter provides for systems and methods for detecting and monitoring one or more criteria of a disease state.

In certain embodiments, the system for monitoring and detecting a disease state can include a communications interface that monitors data exchanged by a hospital information system and at least one clinician, a memory device configured to store information in a central record that includes at least data that results from the monitoring by the communications interface, a processor configured to compare data stored in the memory device and data exchanged from the monitoring by the communications interface and determine if: (1) one or more disease state criteria are present and (2) one or more disease state criteria are indicated, and a communications interface to provide an alert to the hospital information system and at least one clinician if at least one or more disease state criteria are present or indicated.

In certain embodiments, the method for monitoring and detecting a disease state can include monitoring, via a communications interface, data exchanged between a hospital information system and at least one clinician, storing, in a memory device, at least data that results from the monitoring by the communications interface, processing data stored in the memory device and data exchanged from the monitoring by the communications interface and determine if: (1) one or more disease state criteria are present and (2) one or more disease state criteria are indicated, and outputting, via the communications interface, an alert to the hospital information system and at least one clinician if one or more disease criteria are present or indicated.

In certain embodiments, the computer readable medium includes hardware design code stored thereon which when executed by a processor causes the system to detect and categorize a disease state. In certain embodiments, the computer readable medium causes the system to monitor, via a communications interface, data exchanged between a hospital information system and at least one clinician, store, in a memory device, at least data that results from the monitoring by the communications interface, process data stored in the memory device and data exchanged from the monitoring by the communications interface and determine if: (1) one or more disease state criteria are present and (2) one or more disease state criteria are indicated, and output, via the communications interface, an alert to the hospital information system and at least one clinician if one or more disease criteria are present or indicated.

In certain embodiments, the disease state can include, but are not limited to, acute kidney injury, sepsis, and acute respiratory distress syndrome (ARDS). In certain embodiments, the one or more disease state criteria can include, but are not limited to, an increase in serum creatinine levels of greater than or equal to about 0.3 mg/dl within a timeframe of up to about 52 hours or a greater than or equal to about 50% increase in serum creatinine within a timeframe of up to about 52 hours.

### BRIEF DESCRIPTION OF THE DRAWINGS

Understanding of the present invention will be facilitated by consideration of the following detailed description of exemplary embodiments of the present invention taken in conjunction with the accompanying drawings, in which like numerals refer to like parts:

FIG. 1a illustrates a system diagram for monitoring and detecting a disease state according to certain embodiments of the presently disclosed subject matter.

FIG. 1b illustrates an alert provided to a clinician by the system of FIG. 1a according to certain embodiments of the presently disclosed subject matter.

FIG. 2 illustrates a method for monitoring, detecting and categorizing sepsis according to certain embodiments of the presently disclosed subject matter.

FIG. 3 shows an example computing device that can be used to implement features a system and method according to certain embodiments of the presently disclosed subject matter.

FIG. 4 shows a tablet computer that corresponds to certain embodiments of the computing device of FIG. 3 with the alert of FIG. 1b.

FIG. 5 shows a method for monitoring and detecting a disease state according to certain embodiments of the presently disclosed subject matter.

### DETAILED DESCRIPTION

For clarity of disclosure and not by way of limitation the detailed description of the invention is divided into the following subsections:

| | |
|---|---|
| I. | Detection systems and methods; and |
| II. | Indications; |

| | |
|---|---|
| A. | Acute kidney injury; |
| B. | Sepsis; |
| C. | Acute respiratory distress syndrome; and |
| D. | Other disease states. |

### I. Detection Systems and Methods

The presently disclosed subject matter provides for systems and methods for monitoring and detecting one or more disease states. In certain embodiments, the system and method can include a communications interface that monitors data exchanged by a hospital information system and at least one clinician, a memory device configured to store information in a central record that includes at least data that results from the monitoring by the communications interface, a processor configured to compare data stored in the memory device and data exchanged from the monitoring by the communications interface and determine if: (1) one or more disease state criteria are present; and (2) one or more disease state criteria are indicated, and a communications interface to provide an alert to the hospital information system and at least one clinician if at least one or more disease state criteria are present or indicated.

In certain embodiments, the system and method can include a communications interface that monitors data exchanged by a hospital information system and at least one clinician, a memory device configured to store information in a central record that includes at least data that results from the monitoring by the communications interface, a processor configured to compare data stored in the memory device and data exchanged from the monitoring by the communications interface and determine, for example, in embodiments relating to sepsis, if (1) one or more systemic inflammatory response syndrome (SIRS) criteria are present, (2) one or more SIRS criteria are indicated, and (3) new organ dysfunction is present, and a communications interface to provide an alert to the hospital information system and at least one clinician if two or more of the SIRS factors are present or indicated and to elevate the alert if there is a new organ dysfunction present.

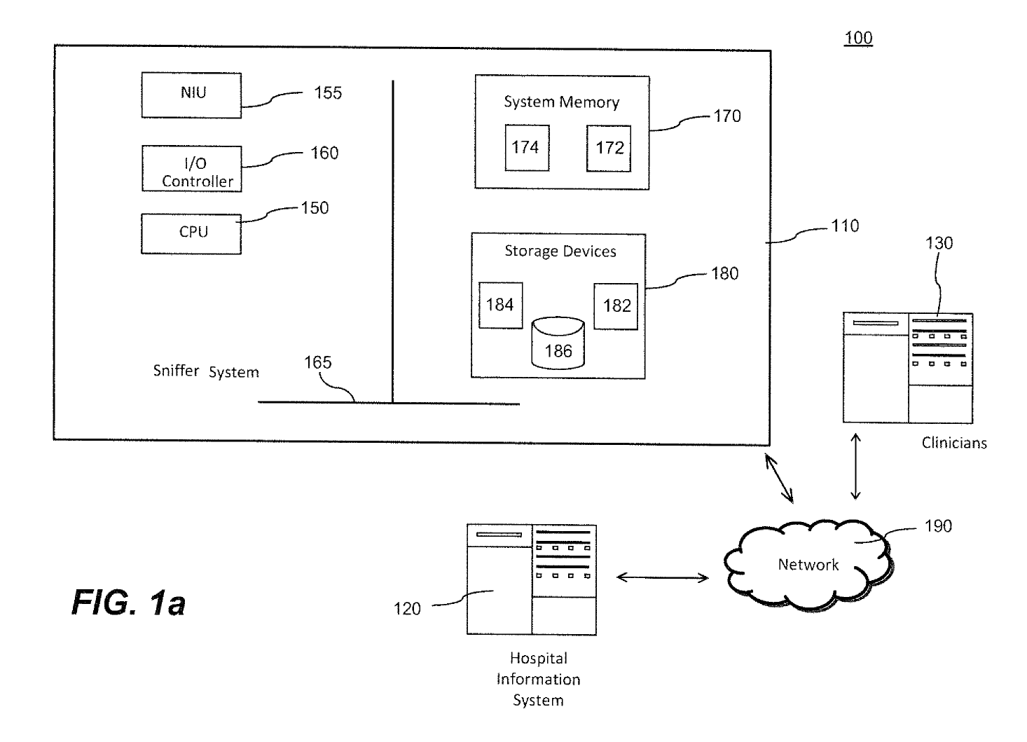

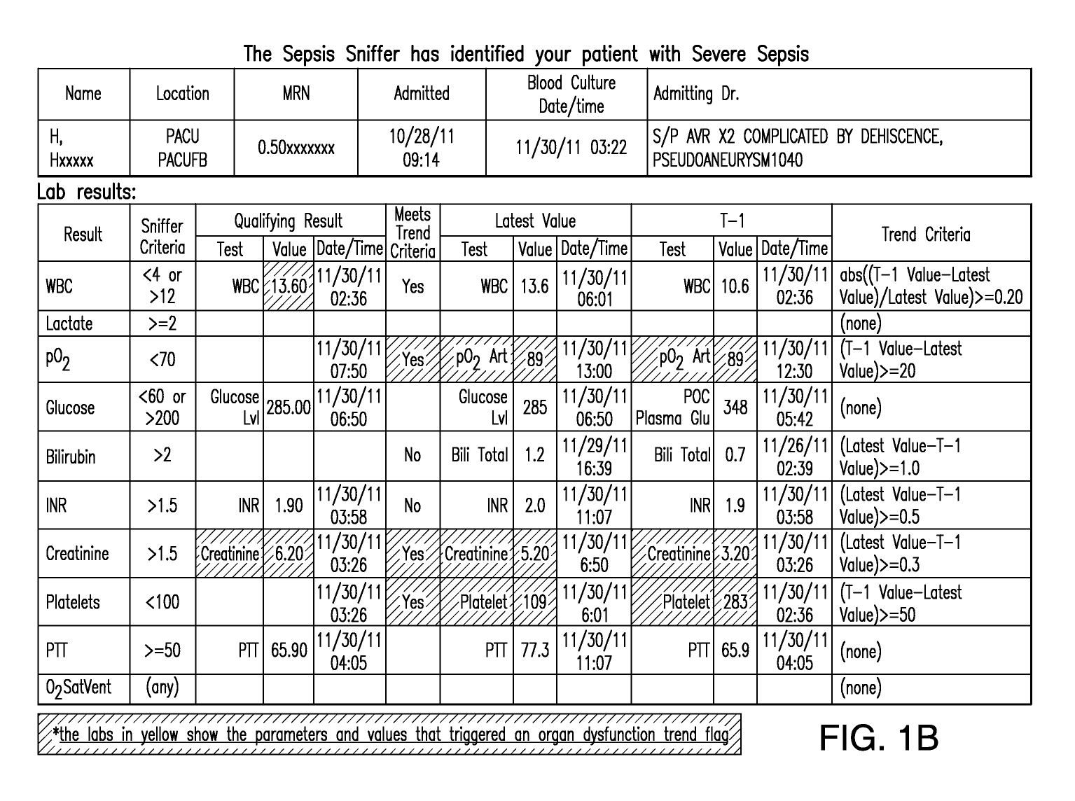

For the purpose of illustration and not limitation, FIG. 1a illustrates a system for monitoring and identifying a disease state in accordance with one embodiment of the disclosed subject matter. For example, the system 100 can be used for monitoring and identifying cases of sepsis and/or acute kidney disease. As shown in FIG. 1a, the sniffer system 110 interacts with hospital information system 120 and clinicians 130 using internet 190. Hospital information system 120 can include digital or digitized records maintained by a medical facility, for example. Data provided by or to hospital information system 120 can pass through the internet 190 to the sniffer system 110. Similarly, clinicians 130 can provide or receive information via the internet 190 to/from alert system 110. Each of hospital information system 120 and clinicians 130 can communicate with one another via internet 190. The sniffer system 110 can be configured to communicate with each hospital information system 120, and clinician 130 via internet 190. System 100 can further include a network interface unit (NIU) 155 to enable communication with one or more hospital information systems 120 and clinicians 130.

In certain embodiments, system 100 can include one or more central processing units (CPU) 150, a network interface unit (NIU) 155, an input/output (I/O) controller 160, system memory 170, one or more storage devices 180, or combinations thereof. Each CPU 150, NIU 155, I/O controller 160, system memory 170, and storage devices 180 can be communicatively coupled via bus 165. System memory 170 can include random access memory (RAM) 172, read only memory (ROM) 174, and one or more caches. Storage devices 180 can include one or more applications 184, an operating system 182, and one or more databases 186. Storage devices 180 can take the form of, but are not limited to, a diskette, hard drive, CD-ROM, thumb drive, hard file, or a Redundant Array of Independent Disks (RAID). System 100 can be accessed via network 190 using a mainframe, thin client, personal computer, mobile device, pad computer, or the like and information processed by CPU 150 and/or operated upon or stored on storage devices 180 and/or in memory 170 can be displayed to a user through a user device (not shown). Operationally, system 100 can monitor and record interactions between and among the sniffer system 110, the one ore more hospital information systems 120, and the one or more clinicians 130.

For the purpose of illustration and not limitation, FIG. 1b illustrates an alert that can be provided to a clinician by the system of FIG. 1a in accordance with one embodiment of the disclosed subject matter. Clinician 130 and/or a team within a hospital information system 120 can be alerted that a patient has a disease state, e.g., AKI, sepsis, or ARDS. This alert can take the form of a text page, email, and/or within the hospital system, or any such technology. An alert can take the form of the alert shown in FIG. 1b. In the alert of FIG. 1b, it is shown a text page or email that describes the alert, and the description includes information that the alert system has identified your patient as having severe AKI, sepsis, or ARDS. The alert can further include additional information. Non-limiting examples of additional information that can be contained within the alert includes, but are not limited to, details showing the patient results and identifying certain results as being used within the determination that caused the alert. In certain embodiments, the cause of the alert is highlighted in yellow.

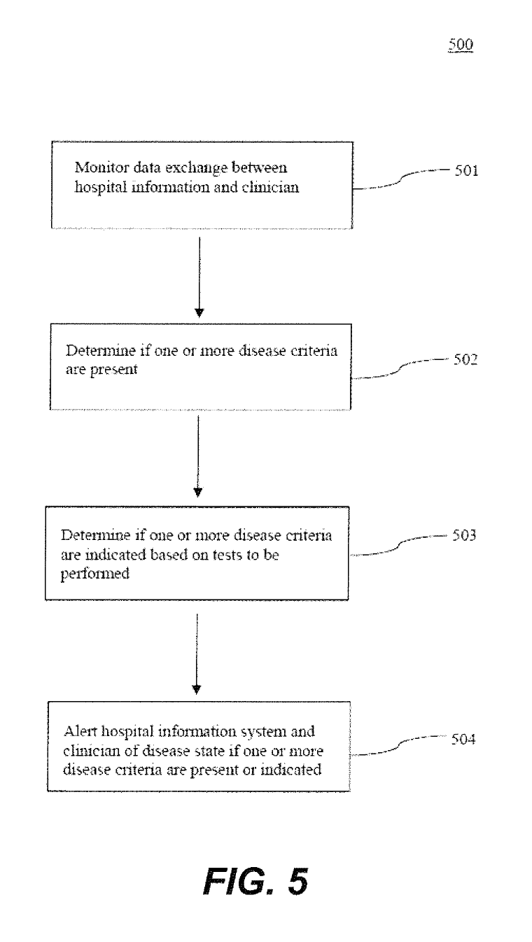

FIG. 5 illustrates a method 500 for detecting and categorizing a disease state, e.g., acute kidney injury, in accordance with one embodiment of the disclosed subject matter. The method 500 includes monitoring data exchanged between hospital information system 120 and clinician 130 at step 510. The method 500 further includes determining if one or more disease criteria of a disease state are present in the monitored data 520 and/or if one or more disease criteria of a disease state are indicated based on tests to be performed as instructed by clinician 530. If one or more disease criteria of the disease state are present and/or indicated, the method 500 can further include alerting the hospital information system 120 and clinician 130 of the disease state 540.

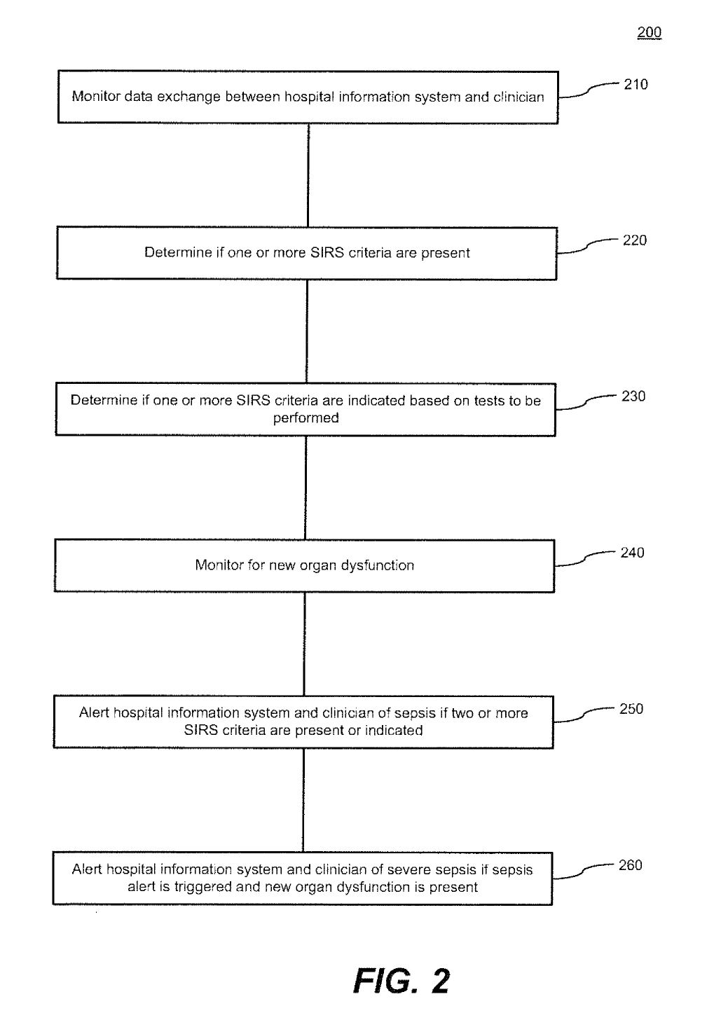

FIG. 2 illustrates a method 200 for detecting and categorizing a sepsis state in accordance with one embodiment of the disclosed subject matter. Method 200 includes monitoring data exchanged between hospital information system 120 and clinician 130 at step 210. Method 200 also includes determining if one or more SIRS criteria are present in the monitored data 220. At step 230, method 200 further includes determining if one or more SIRS criteria are indicated based on tests to be performed as instructed by clinician 130. The method 200 can further include monitoring for new organ dysfunction 240. If two or more SIRS criteria are present and/or indicated, the method 200 can further include alerting the hospital information system 120 and clinician 130 of sepsis 250. At step 260, the method 200 can include alerting hospital information system 120 and clinician 130 of severe sepsis if sepsis is diagnosed and new organ dysfunction is present.

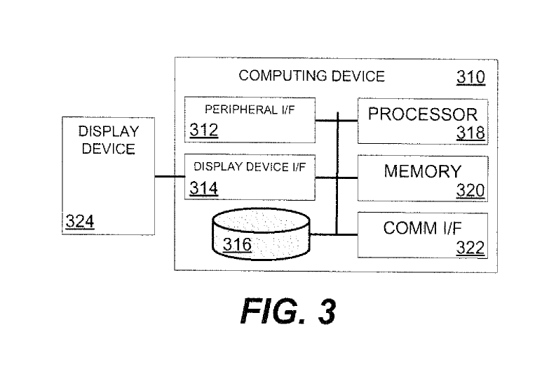

FIG. 3 shows an example computing device 310 that can be used to implement features described above with reference to FIGS. 1 and 2, in accordance with an embodiment of the presently described subject matter. In certain embodiments, the computing device 310 can include a processor 318, memory device 320, communication interface 322, peripheral device interface 312, display device interface 314, and data storage device 316. FIG. 3 also shows a display device 324, which can be coupled to or included within the computing device 310.

In certain embodiments, the memory device 320 can be or include a device such as a Dynamic Random Access Memory (D-RAM), Static RAM (S-RAM), or other RAM or a flash memory. The data storage device 316 can be or include a hard disk, a magneto-optical medium, an optical medium such as a CD-ROM, a digital versatile disk (DVDs), or Blu-Ray disc (BD), or other type of device for electronic data storage.

In certain embodiments, the communication interface 322 can be a communications port, a wired transceiver, a wireless transceiver, a network card or a combination thereof. The communication interface 322 can be capable of communicating using technologies such as Ethernet, fiber optics, microwave, xDSL (Digital Subscriber Line), Wireless Local Area Network (WLAN) technology, wireless cellular technology, and/or any other appropriate technology.

In certain embodiments, the peripheral device interface 312 can be configured to communicate with one or more peripheral devices. The peripheral device interface 312 can operate using a technology such as Universal Serial Bus (USB), PS/2, Bluetooth, infrared, serial port, parallel port, and/or other appropriate technology. The peripheral device interface 312 can, for example, receive input data from an input device such as a keyboard, a mouse, a trackball, a touch screen, a touch pad, a stylus pad, and/or other device. Alternatively or additionally, the peripheral device interface 312 can communicate output data to a printer that is attached to the computing device 310 via the peripheral device interface 312.

In certain embodiments, the display device interface 314 can be one or more interfaces configured to communicate data to a display device 324. Examples of a display device 324 include, but are not limited to, a monitor or television display, a plasma display, a liquid crystal display (LCD), and/or a display based on a technology such as front or rear projection, light emitting diodes (LEDs), organic light-emitting diodes (OLEDs), or Digital Light Processing (DLP). In certain embodiments, the display device interface 314 can operate using technology such as Video Graphics Array (VGA), Super VGA (S-VGA), Digital Visual Interface (DVI), High-Definition Multimedia Interface (HDMI), or other appropriate technology. The display device interface 314 can communicate display data from the processor 318 to the display device 324 for display by the display device 324. As shown in FIG. 3, the display device 324 can be external to the computing device 310, and coupled to the computing device 310 via the display device interface 314. Alternatively, the display device 324 can be included in the computing device 300.

In certain embodiments, the computing device 310 of FIG. 3 can be configured to perform any feature or any combination of features described above as performed by the snifer system 110. Alternatively or additionally, the memory device 320 and/or the data storage device 316 can store instructions which, when executed by the processor 318, cause the processor 318 to perform any feature or any combination of features described above as performed by system 100. Further, each or any of the features described above as performed by system 100 can be performed by processor 318 in conjunction with memory device 320, communication interface 322, peripheral device interface 312, display device interface 314, and/or storage device 316.

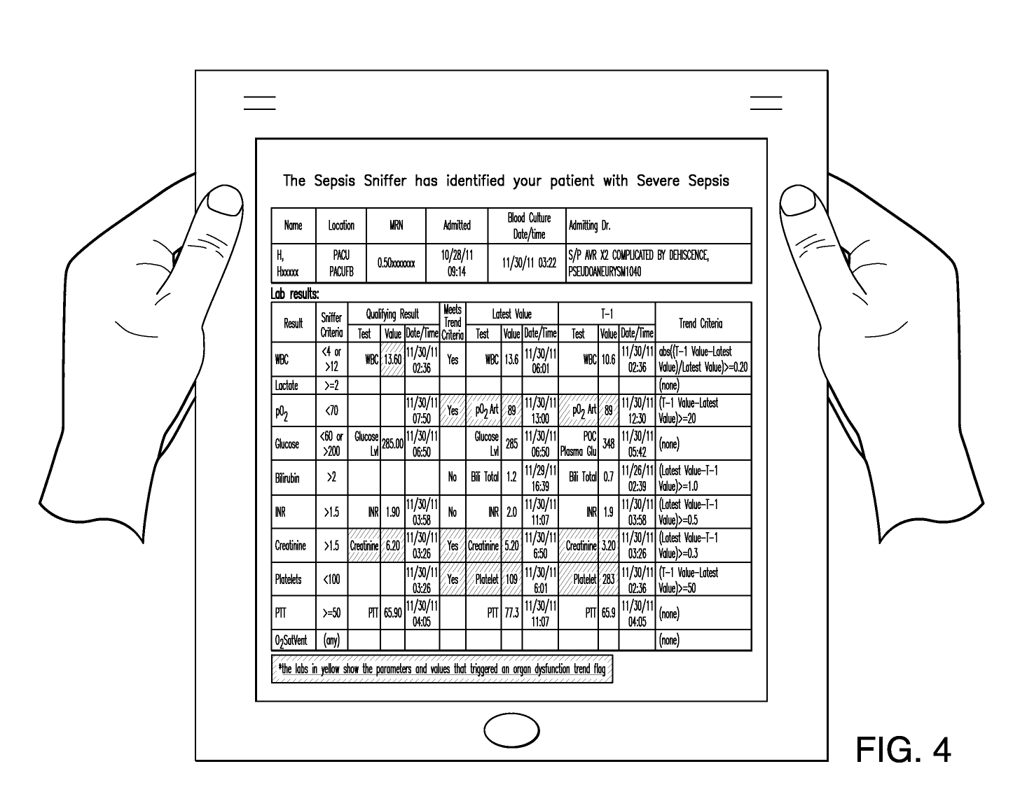

For the purpose of illustration and not limitation, FIG. 4 shows a tablet computer 410 that is a more specific example of the computing device 310 of FIG. 3 showing the alert illustrated in FIG. 1b. In certain embodiments, the tablet computer 410 can include a processor (not depicted), memory device (not depicted), communication interface (not depicted), peripheral device interface (not depicted), display device interface (not depicted), storage device (not depicted), and touch screen display 424, which can possess characteristics of the processor 318, memory device 320, communication interface 322, peripheral device interface 312, display device interface 314, storage device 316, and display device 324, respectively, as described above with reference to FIG. 3. The touch screen display 424 can receive user input using technology such as, for example, resistive sensing technology, capacitive sensing technology, optical sensing technology, or any other appropriate touch-sensing technology.

As used herein, the term “processor” broadly refers to and is not limited to a single-or multi-core processor, a special purpose processor, a conventional processor, a Graphics Processing Unit (GPU), a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine.

As used to herein, the term “computer-readable medium” broadly refers to and is not limited to a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVDs, or 13D, or other type of device for electronic data storage.

Although examples are provided above that relate to a hospital environment and a clinician that provides services to a patient, the features described above with reference to FIGS. 1-4 are also applicable and/or can be used by, mutatis mutandis, any type of business, any type of non-business organization, and/or any individual. For example, the disease state alert can be used by institutions and pharmaceutical companies to facilitate screening for patient enrollment for clinical trials. In certain embodiments, the systems and methods described herein can be used by an institution or pharmaceutical company to screen for adverse events and/or disease states (e.g., acute kidney injury) in patients enrolled in a research trial.

Although the methods and features are described above with reference to the example architecture 100 of FIG. 1a, the methods and features described above can be performed, mutatis mutandis, using any appropriate architecture and/or computing environment. Although features and elements are described above in particular combinations, each feature or element can be used alone or in any combination with or without the other features and elements. For example, each feature or element as described above, and with reference to FIGS. 1-5, can be used alone without the other features and elements or in various combinations with or without other features and elements. Sub-elements and/or sub-steps of the methods described above, and with reference to FIGS. 1-5, can be performed in any arbitrary order (including concurrently), in any combination or sub-combination.

The systems and methods disclosed herein can be integrated into any known patient management system. For example, but not by way of limitation, the system and/or method of the presently disclosed subject matter can be integrated into the Sunrise Clinical Manager System. Additional non-limiting examples of patient management systems that can be used with the presently disclosed subject matter includes, but is not limited to, the Cerner Millennium system, and MedView. Further, the systems and methods disclosed herein can be built or imported into a self-contained program.

### II. Indications

The features of the systems and methods described above with reference to are applicable and/or can be used to monitor and identify any disease state or illness that uses conditions and symptoms as a point of detection.

In certain embodiments, the presently disclosed subject matter provides for systems and methods for monitoring the conditions and symptoms with respect to a patient file and alerting the care provider, e.g., clinician, of a diagnosis or probability of a disease state. Further, the presently disclosed subject matter can be used to more broadly screen hospitalized patients for early detection of organ dysfunction as an efficient way to identify adverse events and alert clinicians. A number of abnormalities and/or disease states, which if identified early, can improve clinical care. For example, but not by way of limitation, a system and method of the present disclosure can be used for identifying and/or monitoring diseases states such as acute kidney injury, sepsis, acute respiratory distress syndrome, central pontine myelinolysis, and acute liver injury by monitoring for one or more disease state criteria, e.g., symptoms and conditions of a disease state.

### A. Acute Kidney Injury

In certain embodiments, the system and method of the disclosed subject matter can be utilized for monitoring and identifying the conditions and symptoms of acute kidney injury. In certain embodiments, the sniffer system 110 can be designed to identify cases of AKI, and provide an alert to a clinician 130.

In certain embodiments, the method to monitor and identify the conditions and symptoms of acute kidney injury includes monitoring data exchanged between at least one hospital information system and at least one clinician. The method can include determining if one or more disease criteria of AKI are present in the monitored data and/or determining if one or more disease criteria of AKI are indicated based on tests to be performed as instructed by a clinician.

In certain embodiments, the disease state criteria for AKI can include, but are not limited to, symptoms associated with AKI, such as changes in the creatinine levels of a patient. For example, determining the changes in the creatinine levels of a patient can include scanning the serum creatinine values of the patient. In certain embodiments, the system can scan serum creatinine levels of a patient every hour, every 2 hours, every 3 hours, every 6 hours, every 12 hours, every 24 hours, every 48 hours, every 52 hours, every one 172 hours or every 336 hours.

In certain embodiments, the change in creatinine levels can be determined as the difference between two serum creatinine levels measured within a relevant timeframe. In certain embodiments, one of the disease state criteria for AKI can include detecting an increase in serum creatinine levels of greater than or equal to about 0.2 mg/dl, greater than or equal to about 0.25 mg/dl, or greater than or equal to about 0.3 mg/dl within a relevant timeframe. In certain embodiments, one of the disease state criteria for AKI can include detecting an increase of greater than or equal to about 25%, greater than or equal to about 30%, greater than or equal to about 40%, greater than or equal to about 45%, greater than or equal to about 50% in a patient's creatinine levels within a relevant timeframe. For example, the change in creatinine levels can be determined from two creatinine levels within a timeframe of up to about 6 hours, up to about 12 hours, up to about 24 hours, up to about 48 hours, up to about 52 hours, up to about 172 hours, or up to about 336 hours.

In certain embodiments, one of the disease state criteria for AKI can include detecting an increase in serum creatinine levels of greater than or equal to about 0.3 mg/dl within a timeframe of up to about 52 hours.

In certain embodiments, one of the disease state criteria for AKI can include detecting a greater than or equal to about 50% increase in serum creatinine within a timeframe of up to about 52 hours. In certain embodiments, the change in creatinine levels is an increase of greater than or equal to 25%.

In certain embodiments, the system and method to monitor and identify AKI in a patient can further include the application of specific rules to exclude certain patients from receiving inappropriate alerts. For example, patients receiving chronic dialysis therapy may receive inappropriate alerts if not properly excluded from the system. The creatinine level of a patient immediately after dialysis is rapidly reduced, which, in turn, may lead to a subsequent alert as creatinine rises towards pre-dialysis levels. In certain embodiments, patients having an initial creatinine level of greater than or equal to about 4.0 mg/dl can be excluded from receiving alerts. In certain embodiments, patients with a prior nephrectomy can also be excluded from receiving an alert.

The method and system can further include, signaling detection of AKI if one or more of the disease criteria for AKI have been detected and initiating an alert to care providers, e.g., clinicians and/or pharmacist responsible for the patient. Care providers can include any individual or institution responsible for the monitoring, treating, diagnosing, and/or rehabilitation of a patient. For example, but not by way of limitation, care providers can include clinicians, nurses, physician assistants, nurse practitioners, pharmacists, researchers, pharmaceutical companies, and testing laboratories.

In certain embodiments, the alert can be sent by text page to the clinician caring for the patient as well and/or the local clinical pharmacist responsible for that patient. In certain embodiments, the system can be integrated into a patient management system, i.e., Allscripts Sunrise Clinical Manager (SCM) system, to trigger the alert to the provider at the time the provider signs on to the management system. The integration of the disclosed system and methods into a management system can allow the care provider to view the alert in the context of the patient's medical records. For example, an alert indicating that a patient has AKI can be accompanied by a suggestion that the clinician should consider holding, stopping, or adjusting the dose of medications that can cause or worsen renal function (e.g., ACE-I and NSAIDs). In addition, any contrast studies that may be ordered can be presented for consideration to abort. Further, a panel of diagnostic studies can be suggested to promote further investigation, e.g., ultrasound, and interventions that may be effective in treating the patient can also be offered, e.g., intravenous fluid (IVF) boluses.

### B. Sepsis

In certain embodiments, the system and method of the disclosed subject matter can be utilized for monitoring, identifying, and categorizing sepsis. In certain embodiments, the sniffer system (the “sepsis sniffer”) 110 can be designed to identify cases of sepsis, determine the severity of the sepsis, and provide an alert to clinician 130. In certain embodiments, a patient is diagnosed with sepsis when there is a suspected or proven infection accompanied by at least two SIRS criteria. In certain embodiments, a patient is diagnosed with sepsis when at least two, at least three, or at least four SIRS criteria are indicated and/or present.

In certain embodiments, the system and method for monitoring, identifying, and categorizing sepsis can include a communications interface that monitors data exchanged by a hospital information system and at least one clinician, a memory device configured to store information in a central record that includes at least data that results from the monitoring by the communications interface, a processor configured to compare data stored in the memory device and data exchanged from the monitoring by the communications interface and determine if (1) one or more SIRS criteria are present, (2) one or more SIRS criteria are indicated, and (3) new organ dysfunction is present, and a communications interface to provide an alert to the hospital information system and at least one clinician if two or more of the SIRS factors are present or indicated and to elevate the alert if there is a new organ dysfunction present.

SIRS is an inflammatory state affecting the whole body that is frequently a response of the immune system to infection. Non-limiting examples of SIRS criteria include:

1. Body temperature. In certain embodiments, body temperature of less than or equal to about 36° C. or greater than or equal to about 38° C., indicating the presence of hypothermia or a fever, respectively, can be a SIRS criteria. In certain embodiments, temperature <36° C. (96.8° F.) or >38° C. (100.4° F.)) can be measured.

2. Heart rate. In certain embodiments, a heart rate greater than about 90 beats per minute (Heart rate >90/min) can be a SIRS criteria.

3. Respiratory rate. In certain embodiments, tachypnea (high respiratory rate), with greater than about 20 breaths per minute or an arterial partial pressure of carbon dioxide less than 4.3 kPa (32 mmHg) (Respiratory rate >20/min or PaCO₂<32 mmHg (4.3 kPa)), can be a SIRS criteria.

4. White blood cell count (WBC). In certain embodiments, white blood cell count less than about 4000 cells/mm³ (4×109 cells/L) or greater than about 12,000 cells/mm³ (12×109 cells/L), or the presence of greater than about 10% immature neutrophils (band forms) (WBC<4×109/L (<4000/mm³), >12×109/L (>12,000/mm³), or >10% bands), can be a SIRS criteria.

In certain embodiments, in addition to SIRS criteria being detected by monitoring results of a performed test, SIRS criteria can be indicated based on tests that are to be performed, as requested by a clinician. For example, a test for a blood culture can be indicative of a fever, which is a SIRS criteria.

In certain embodiments, information related to these criteria can be included in the hospital information system 120. For example, when a clinician 130 requests a white blood cell count, the results of such request can be stored and recorded within a hospital information system 120. These values may be included in the file as the test results or measurements are entered. The system of the presently disclosed subject can send an alert based on the values in the file.

In certain embodiments, the diagnosis of sepsis can be made by the sniffer system 110 utilizing at least two SIRS criteria, such as, the patient's WBC count and a clinician's 130 order for a blood culture. A clinician's 130 order for a blood culture can be indicative of a fever, as this is the underlying reason a clinician 130 requests a blood culture. Further, the request for a blood culture suggests the clinician 130 suspects infection as the cause of the fever because the purpose of a blood culture is to determine if a pathogen is in the bloodstream. In certain embodiments, system 100 can provide an alert to a clinician 130, if both the WBC count and the blood culture request occur within some predetermined period of time. This time can be preset or adjusted by system 100. For example, the period of time can be within a 2 hour period, a 3 hour period, a 6 hour period, a 12 hour period, a 24 hour period, a 48 hour period, or a 72 hour period. In this example, the order for a blood culture is indicative of a fever, one of the SIRS criteria. Other tests being requested can also trigger the SIRS criteria as the order for the test is caused by the underlying symptom that makes up the SIRS criteria. Combinations of test ordering may be a trigger to capture the SIRS criteria.

In certain embodiments, sepsis is determined to be severe when the sepsis is associated with any new organ dysfunction. The organ dysfunction needs to be new onset organ dysfunction. Thus, a determination whether the organ dysfunction is new can be made. In certain embodiments, the system 100 interacts with a hospital information system 120 to access all the organ function labs available. Once these labs are accessed, the sniffer system 110 can utilize labs within a preset period from the window defined by the at least two SIRS criteria, such as the request of a blood culture and a WBC. In certain embodiments, this preset period can be up to a 2 hour period, a 3 hour period, a 6 hour period, a 12 hour period, a 24 hour period, a 48 hour period, or a 72 hour period. Sniffer 110 can then compare these labs with to the preceding values available in the record. In certain embodiments, if the change in the lab readings reaches a certain threshold, as will be discussed below, sniffer 110 classifies the sepsis as severe. The organ dysfunction can be determined by laboratory values, which can be stored in hospital information system 120. For example, system 100 can accumulate the organ function laboratories and information within a 24 hour window of a blood culture and white blood count, and then the system 100 can compare the results with preceding values available in the medical record.

1. One non-limiting example of an organ function that can be monitored is renal dysfunction, which can include kidney issues. A trigger associated with renal dysfunction can include detecting an increase in serum creatinine levels of greater than or equal to about 0.2 mg/dl, greater than or equal to about 0.25 mg/dl, or greater than or equal to about 0.3 mg/dl within a relevant timeframe, such as within a 52 hour period. In certain embodiments, detecting an increase of greater than or equal to about 25%, greater than or equal to about 30%, greater than or equal to about 40%, greater than or equal to about 45%, greater than or equal to about 50% in a patient's creatinine levels within a relevant timeframe, as discussed above, can trigger renal dysfunction. These changes can be determined by sniffer 110 interacting with hospital information system 120. Oliguria, which is low urine output, can also be monitored to indicate kidney issues. In certain embodiments, oliguria is diagnosed and/or identified when there is a urine output of less than or equal to about 300 or less than or equal to about 500 ml/day. In certain embodiments, renal dysfunction can be monitored for ↑Cr(by 50%, or ↑≧0.3w/i48 hrs), and/or oliguria.

2. An additional non-limiting example of an organ function that can be monitored is Gastrointestinal (GI) dysfunction. In certain embodiments, a trigger for GI dysfunction can include a detection of increased bilirubin greater than about 2 mg/dl. Gastrointestinal dysfunction monitoring can include monitoring for ileus, which is decreased motor activity of the gastrointestinal tract due to non-mechanical causes. In certain embodiments, GI dysfunction can be monitored for: ↑Bili(>2.0), and/or ileus.

3. Heme dysfunction can also be monitored. In certain embodiments, heme can be monitored for a decreased platelet count of less than or equal to about 100,000. Such a decrease may affect the clotting response of blood. Herne can be monitored using prothrombin time. In certain embodiments, prothrombin time can be monitored for extrinsic coagulation, wherein INR is greater than or equal to about 1.5, and intrinsic coagulation, wherein PTT is greater than or equal 60, is indicative of heme dysfunction. In certain embodiments, heme can be monitored for ↓Pitt(<100K), ↑INR(>1,5) and or ↑PTT(>60).

4. Central nervous system (CNS) dysfunction can be monitored. In certain embodiments, a Glasgow coma score, which is a neurological score, can be compared to previous scores. For example, but not by way of limitation, if the score decreases by greater than or equal to 2 stages, CNS dysfunction may be present and therefore triggered in sniffer 110. In certain embodiments, the CNS dysfunction can be monitored for ΔMS and/or ↓GCS(by ≧2).

5. Respiratory dysfunction can be monitored using oxygen saturation. In certain embodiments, respiratory dysfunction can be diagnosed and triggered if there is a decrease in P0₂/0₂SAT. For example, if P/F is less than or equal to 300, respiratory dysfunction can be triggered. In certain embodiments, respiratory monitoring for respiratory dysfunction can include monitoring for: ↓PO2/02SAT (P/F≦300).

6. Cardiovascular dysfunction can also be monitored. In certain embodiments, triggers for this dysfunction can include systolic blood pressure decreases where the systolic blood pressure is less than or equal to about 90 or where the systolic blood pressure decreases by about 40 points. In certain embodiments, an increase in a lactate score of greater than 2 indicating the presence of lactic acid can trigger a diagnosis of cardiovascular dysfunction. In certain embodiments, cardiovascular dysfunction monitoring can include monitoring for ↓SBP(<90 or ↓ by 40) and/or ↑Lactate(>2.0).

The triggering threshold in the monitoring can vary depending on the underlying reading that is being monitored. In order to provide some basis of the thresholds that can be used in the present system, a table of values is included. Table 1 provides a threshold or meaning to certain thresholds for certain data points as monitored by system 100.

TABLE 1

| | Threshold | SQL WHERE | | |
|---|---|---|---|---|
| Class Name | Desc | clause | Order | Trend Flag |
| Bilirubin | >2 | {value} > 2 | 4 | (Latest1 Value − Latest2Value >= 1.0 |
| Creatinine | >1.5 | {value} > 1.5 | 6 | (Latest1Value − Latest2Value) >= 0.3 or |
| | | | | (Latest1Value − Latest2Value/Latest1Value >= |
| | | | | 0.5 but either trend must be w/i 48 hour time |
| | | | | period |
| Glucose | <60 or >200 | {value} < 60 or | 3 | If >200 (latest1Value − Latest2Value) > 50 |
| | | {value} > 200) | | |
| INR | >1.5 | {value} > 1.5 | 5 | (Latest1Value − Latest1Value) >= 0.5 |
| Lactate | | {value >= 2 | 1 | Any value > 2 |
| 02SatVent | (any) | {value} (any) | 9 | Latest1Value − Latest2Value) <= −4%, or any |
| | | | | new order for oxygen |
| Platelets | <100 | {value < 100 | 7 | (Latest2Value − Latest1Value) >= 50 |
| PO2 | <70 | {value} < 70 | 2 | (Latest2Value − Latest1Value) >= 20 |
| PTT | >=50 | {value} >= 50 | 8 | (Latest2Value − Latest1Value) >= 10 |
| Anion Gap | >14 | {value} > 14 | | (Latest2Value − Latest1Value) >= 4 |

In certain embodiments, each of these organ function metrics can be monitored, and in the event that one or more are triggered, the determined sepsis can be elevated to severe sepsis. If severe sepsis is determined, an alert can be sent to clinician 130 and/or to hospital information system 120.

### C. Acute Respiratory Distress Syndrome

In certain embodiments, the present disclosure further provides for early detection and monitoring of acute respiratory distress syndrome (ARDS).

In certain embodiments, a method for detecting and monitoring ARDS can include monitoring data exchanged between hospital information system and a clinician. The method can further include determining if one or more disease criteria of ARDS are present in the monitored data and/or determining if one or more disease criteria of ARDS are indicated based on tests to be performed as instructed by clinician. The method can further include alerting the hospital information system and clinician of the presence of ARDS if one more disease criteria of ARDS are present and/or indicated.

In certain embodiments, the one or more criteria for detecting ARDS includes, but is not limited to, intubation of the patients, patient admittance into the Medical Intensive Care Unit (MICU), Coronary Care Unit (CCU), or Surgical Intensive Care Unit (SICU), monitoring a patient's bilateral infiltrate, and drawing of arterial blood. An additional non-limiting example of a criterion to be monitored for ARDS includes the monitoring of oxygen saturation. In certain embodiments, the system can send an alert for ARDS to the care provider if the P/F ratio of the patient is less than or equal to 300. In certain embodiments, a patient that is intubated can trigger an alert for ARDS.

In certain embodiments, the methods and systems to detect ARDS can include the application of specific rules to exclude certain patients from receiving inappropriate alerts. For example, patients that had their intubation tubes removed may receive inappropriate alerts if not properly excluded from the system. In certain embodiments, patients suffering from congestive heart failure, patients that have undergone surgery within a 24 hour timeframe, patients that had their intubation tubes removed, and patients that do not have edema, have mild edema, or have edema that is improving, can be excluded from triggering alerts regarding ARDS.

### D. Additional Disease States

Although systems and methods are provided above that relate to diagnosing sepsis, acute respiratory distress syndrome and acute kidney injury, the systems and methods of the disclosed subject matter are applicable to all diseases or illnesses that use conditions and symptoms as a point of detection.

For example, in certain embodiments, the present disclosure can be used to provide early detection of thrombocytopenia that can provide early detection of Heparin-induced thrombocytopenia (HIT) syndrome. In such a system, a trigger for thrombocytopenia can alert the clinician to hold heparin given the increased risk for bleeding by detecting another drug side effect. In certain embodiments, the system can alert the clinician of thrombocytopenia if a decrease in platelets of about greater than or equal to about 30% from prior levels is detected, and if this decrease is associated with the administration or order of heparin within a 24 hour period or for about greater than or equal to about 5 consecutive days.

In certain embodiments, the presently disclosed subject matter can be used to alert clinicians that a patient may be bleeding. For example, one of the criteria to be used can be the detection of a decrease in Hemoglobin (HgB) levels. In certain embodiments, the presently disclosed subject matter can be used to monitor an increase in total bilirubin to alert the clinician to stop hepatotoxic drugs and discontinue acetaminophen, e.g., Tylenol.

In certain embodiments, the presently disclosed subject matter can be used to monitor changes in serum glucose and alert a clinician about the high risk for hypoglycemia. For example, the system can monitor for rapid decreases in glucose levels. The system can also monitor for hyperglycemia, wherein rapid increases in glucoses levels can alert a clinician to the dangers of hyperglycemia. In certain embodiments, the trigger to alert a clinician of a patient with hyperglycemia can include the detection of glucose levels greater than about 200 mg/dl. The alert can further suggest to the clinician to increase or begin insulin administration.

In certain embodiments, changes in bicarbonate (HCO₃) or anion gap can be monitored by the present invention to alert to underlying critical illnesses.

In certain embodiments, the presently disclosed subject matter can be used to detect and/or monitor for central pontine myelinolysis (CPM). CPM is a neurological disease caused by severe damage of the myelin sheath of nerve cells. CPM can occur as a complication of treatment of patients with hyponatremia, i.e., low sodium levels in the blood, or occur as a complication of rapid changes in serum sodium levels. In certain embodiment, the system can monitor serum sodium levels. For example, the system can send an alert when the serum sodium levels change greater than about 1 mEq/L in about 1 hour. In certain embodiments, the change is serum levels to trigger an alert can be from about 0.5 to about 2.0 mEq/L in about 1 hour within a time frame of about 6 to about 18 hours. The system can further detect the glucose concentration to determine the net change in osmolarity.

In certain embodiments, an order for oxygen and/or an order for a fluid bolus can be monitored. Documentation of urine output of about equal to or less than 500 ml in about 24 hours or about equal to or less than 250 ml in about 12 hours, documentation of change in mental status or delirium, and/or documentation of mottling of skin or cyanosis can also be monitored.

It is to be understood that the figures and descriptions of the present disclosure have been simplified to illustrate elements that are relevant for a clear understanding of the present disclosure, while eliminating, for the purpose of clarity, many other elements found in computer systems and/or medical diagnostic systems. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Although the invention has been described and pictured in an exemplary form with a certain degree of particularity, it is understood that the present disclosure of the exemplary form has been made by way of example, and that numerous changes in the details of construction and combination and arrangement of parts and steps may be made without departing from the spirit and scope of the invention as set forth in the claims hereinafter.

What is claimed is:

1. A system for detecting and categorizing a disease state, said system comprising:
a communications interface that monitors data exchanged by a hospital information system and at least one clinician;
a memory device configured to store information in a central record that includes at least data that results from the monitoring by the communications interface;
a processor configured to compare data stored in the memory device and data exchanged from the monitoring by the communications interface and determine if:
one or more disease state criteria are present; and
one or more disease state criteria are indicated; and
a communications interface to provide an alert to the hospital information system and at least one clinician if one or more disease state criteria are present or indicated.

2. The system of claim 1, wherein said disease state is acute kidney injury.

3. The system of claim 2, wherein said one or more disease state criteria comprises an increase in serum creatinine levels of greater than or equal to about 0.2 mg/dl within a timeframe of up to about 52 hours.

4. The system of claim 2, wherein said one or more disease state criteria comprises a greater than or equal to about 25% increase in serum creatinine within a timeframe of up to about 52 hours.

5. A method for detecting and categorizing a disease state, said method comprising:
monitoring, via a communications interface, data exchanged between a hospital information system and at least one clinician;
storing, in a memory device, at least data that results from the monitoring by the communications interface;
processing data stored in the memory device and data exchanged from the monitoring by the communications interface and determine if:
one or more disease state criteria are present; and
one or more disease state criteria are indicated; and
outputting, via the communications interface, an alert to the hospital information system and at least one clinician if one or more disease state criteria are present or indicated.

6. The system of claim 5, wherein said disease state is acute kidney injury.

7. The system of claim 6, wherein said one or more disease state criteria comprises an increase in serum creatinine levels of greater than or equal to about 0.2 mg/dl within a timeframe of up to about 52 hours.

8. The system of claim 6, wherein said one or more disease state criteria comprises a greater than or equal to about 25% increase in serum creatinine within a timeframe of up to about 52 hours.

9. A computer readable medium including hardware design code stored thereon which when executed by a processor cause the system to detect and categorize a disease state, said method comprising:
monitoring, via a communications interface, data exchanged between a hospital information system and at least one clinician;
storing, in a memory device, at least data that results from the monitoring by the communications interface;
processing data stored in the memory device and data exchanged from the monitoring by the communications interface and determine if:
one or more disease state criteria are present; and
one or more disease state criteria are indicated; and
outputting, via the communications interface, an alert to the hospital information system and at least one clinician if one or more disease state criteria are present or indicated.
